(19) United States
(12) Patent Application Publication
(10) Pub. No.: US 2024/0043242 A1
(43) Pub. Date: Feb. 8, 2024

(54) ELEVATOR INSTALLATION AND IDENTIFICATION METHOD

(71) Applicant: Inventio AG, Hergiswil (CH)

(72) Inventor: Antonio Perfetto, Ebikon (CH)

(21) Appl. No.: 18/257,888

(22) PCT Filed: Dec. 17, 2021
(86) PCT No.: PCT/EP2021/086380

§ 371 Date: Jun. 16, 2023

(30) Foreign Application Priority Data
Dec. 23, 2020 (EP) 20216918.1

(51) Int. Cl. B66B 1/34; B66B 13/02

(52) U.S. Cl. CPC B66B 1/3461; B66B 13/02

(57) ABSTRACT

An elevator system includes a data network and is operated according to a method for identifying a component of the elevator system. The data network has at least one network node including a component of the elevator system. The component of the network node can be identified such that a control unit of the elevator system controls a light source in order to generate a light signal to indicate the network node. The component can be assigned to a light sensor when the light sensor detects the light signal, and the control unit is notified of the assignment of the component.

### FIELD

The invention relates to an elevator system comprising a data network, and to a method for identifying a component of the elevator system.

### BACKGROUND

In elevator systems which have an elevator car in an elevator shaft, the elevator car moves between different floors (foyers) of a building in order to transport passengers. In order to be able to ensure the safety of passengers or service personnel, many parts, components, and sensors within the elevator system must be constantly monitored, or it must be guaranteed that they can communicate with one another. A safety-relevant component is, for example, a shaft door or car door which is only opened at a floor when the elevator car arrives at this floor. The elevator car may or can only move if the shaft doors and car doors are closed.

Currently, an elevator system often communicates to or from the outside via a public network, and within the elevator system a local network, such as an LAN (local area network), is created in order to interconnect such safety-relevant parts, components, and sensors and to enable data exchange between the individual network participants. Compared with cable-based field bus and LAN networks, the number of wireless networks, such as Wi-Fi, in the elevator industry is still low, but demand is steadily increasing. In addition, modern network technology allows various new services with an elevator system in building management and provides flexibility for a plurality of different types of use, such as the Internet of Things (IoT), an increasing networking of devices, sensors, etc. via IP network, which uses the TCP/IP protocol. Any device including one or more elevator systems can be connected to the Internet and other connected devices.

In a network, a network node (or node) is a connection point that can either be a redistribution point or an end point in data transfers. The network node is able to recognize, process and forward data transfers for other network nodes in this network. In an IP network, each network node requires an individual IP address (Internet protocol address), which is normally distributed by a gateway or router, so that the network node can be addressed for data communication. If data communication takes place via Wi-Fi, IP addresses are generally assigned dynamically, i.e., a network node does not always get the same IP address. It is therefore usually not possible to determine the position of a network node solely by means of an IP address assigned thereto. In particular, it is difficult to identify a component or a part of the elevator system using a variable IP address. The situation could be even more complex if there are several equivalent or identical components in the same place, such as several shaft doors on one floor, or a car with more than one car door. The doors, which are designed in the same way, are arranged on the same application layer and exchange data with network nodes (e.g., elevator car), but on a communication layer. It is inconvenient for the control system of an elevator system to recognize or identify such doors individually. In addition, it is difficult for wireless signals to propagate through the interior walls of a building between network nodes or in a region comprising metal (e.g., an elevator shaft) or other radio-wave damping materials (e.g. reinforced concrete). Although every piece of hardware has its own MAC (media access control) address, which remains fixed and serves as the only identifier for the particular piece of hardware, the MAC addresses cannot replace IP addresses for data security reasons and at the current technical level.

### SUMMARY

If components of an elevator system are interconnected as network nodes of a network, there may be a need, among other things, to identify one or more components of one of the parts in a simple manner, in particular during installation and maintenance work on the elevator system.

Such a need can be met by the subject matter of any of the advantageous embodiments defined in the following description.

According to the invention, an elevator system is provided with a data network, the data network comprising at least one network node, the network node comprising a component of the elevator system. The data network can be a local data network set up within the elevator system, or a regional (e.g. MAN: Metropolitan Area Network) regional network or a public network (e.g. WAN: Wide Area Network) or the Internet to which the elevator system is connected. In a data network, data communication takes place via various protocols, such as TCP/IP (transmission control protocol/internet protocol). A data network can communicate with other data networks and can itself contain subnetworks. A network address can be assigned to the network node. In the case of an IP network, IP addresses are usually distributed by a gateway or router. The component of the network node can be identified such that a control unit of the elevator system can control a light source in order to generate a light signal to indicate the network node. The light source can be located at the network node, for example, or assigned thereto. The control unit is, for example, the main controller or a sub-controller of the elevator system or a separate controller outside the elevator system. The component can be assigned to a light sensor when the light sensor detects the light signal. This assignment could be a direct assignment between the component and the light sensor, or an indirect assignment, i.e., the component can be assigned to the light sensor with the aid of an intermediate stage/interface, such as another component of the elevator system or another network node. In the context of this invention, the assignment does not mean that the component must have a permanent association or relationship with this light sensor. The control unit can then be notified of the assignment of the component to the light sensor, i.e., this assignment can be determined for the control unit. Such a notification or determination can take place in the same way via the network node or another network node. Since the light sensor has its own characteristic, for example its position, the component can be distinguished from other components of this network node. That is, if the light sensor is in a known position, the position of the component can consequently likewise be determined directly or indirectly.

According to an advantageous embodiment of the invention, the network node can inform the control unit of the network address of the network node and/or the network address of another network node. This can be done by also connecting the control unit to the data network, for example. Then the control unit will regard the network node or the other network node as an available network node and control the light source such that the light source can light up accordingly, so that the available network nodes are displayed. For such a control, the control unit can, for example, send a digital signal to the light source, such as a digital signal “1” for an available network node, and a digital signal “0” otherwise. Therefore, the light source can indicate the network node by lighting up. The availability of a network node can be confirmed, for example, when this network node occupies a network address.

According to an advantageous embodiment of the invention, the network node can be designed for or by a stopping station of a car of the elevator system. The elevator system is normally installed in a building with several floors, with a stopping station for the elevator car being provided on each floor. There is not always only one shaft door on a floor; there could be more than one shaft door or no shaft door.

The light source is, for example, close to a shaft door of the network node. The light sensor can detect a light signal that is emitted by the lit-up light source. The position of the shaft door can be discovered via the light sensor because the shaft door is also roughly in the same position as the light sensor or in the vicinity thereof. This could be particularly helpful with elevator control, since it is not necessary to position a component precisely, but only to differentiate it from the other components. For example, there are two shaft doors on one floor. The car—likewise as a different network node—must therefore also have two car doors. Since the network node comprises two identical doors, but only one network address is occupied, the different doors cannot be identified individually. In this case, for example, there can be a left-hand shaft door and a right-hand shaft door in one stopping station, for example, and the two car doors are set up separately, for example on the left-hand side and on the right-hand side of the elevator car.

According to a further advantageous embodiment of the invention, the car of the elevator system can form the network node of the data network, the component of the network node then being given as a car door of the car. In this case, the car can have at least two car doors. Accordingly, at least two light sensors can be provided, it being possible to identify one of the light sensors differently according to its position with respect to the other light sensor or sensors, such as a light sensor on the left, and a light sensor on the right, etc. The light sensor can be arranged on the car, for example on the roof of the car. The light sensor can then reach or approach all floors by moving the car. In this way, it is easy to determine how many shaft doors there are and where the shaft doors are. If the car comprises more than one car door, such as a left-hand and a right-hand car door, it can also be easy to identify which is the left-hand door and which is the right-hand door by the car notifying the control unit of the elevator system of which light sensor detects a light signal and which car door is assigned to this light sensor. The two car doors are thus clearly identified for the control unit on the basis of the assignment to the different light sensors. The work of installing an elevator system can be considerably simplified or facilitated. For example, if the elevator car has several identical shaft doors or car doors, the shaft doors or car doors can be easily identified rather than being recognized incorrectly by a control system and mixed up when controlling an elevator system.

According to another advantageous embodiment of the invention, a stopping station of the car can be determined by the network address of the network node if the network node corresponds to the stopping station. This is done by the control unit, for example, because the network node can notify the control unit of its network address. In other words, the floor on which the network node is located can be determined by the control unit from the network address of this network node.

According to another advantageous embodiment of the invention, the light source is provided for illuminating an elevator shaft or a stopping station or lobby of the elevator system. In this case, the light source can comprise one or more light-emitting diodes (LEDs), or it can be designed as a strip of several light-emitting diodes, wherein the LEDs can emit different colors. The strip will, for example, extend continuously in one piece or in several pieces along an elevator shaft. The light sensor is an optical sensor that is arranged, for example, on the roof of the elevator car or in the vicinity of the light source on the shaft wall.

In addition, a method is provided for identifying a component of an elevator system with a data network, the data network having at least one network node, and the network node comprising a component of the elevator system. In the method, the component of the second network node is identified such that a light source is controlled by a control unit of the elevator system so as to generate a light signal to indicate the network node. The component is assigned to a light sensor when the light sensor detects the light signal, and the control unit is notified of the assignment of the component to the light sensor.

It should be noted that some of the possible features and advantages of the invention are described herein with reference to various embodiments both of the illumination device and of a method for illuminating an elevator shaft of an elevator system. A person skilled in the art will recognize that the features can be suitably combined, adapted, or replaced in order to arrive at further embodiments of the invention.

Embodiments of the invention will be described below with reference to the accompanying drawings, wherein neither the drawings nor the description are intended to be interpreted as limiting the invention.

### DESCRIPTION OF THE DRAWINGS

In the drawings:

FIG. 1 is a schematic view of an elevator system according to the invention, and

FIG. 2 is a schematic view of an identification method according to the invention.

### DETAILED DESCRIPTION

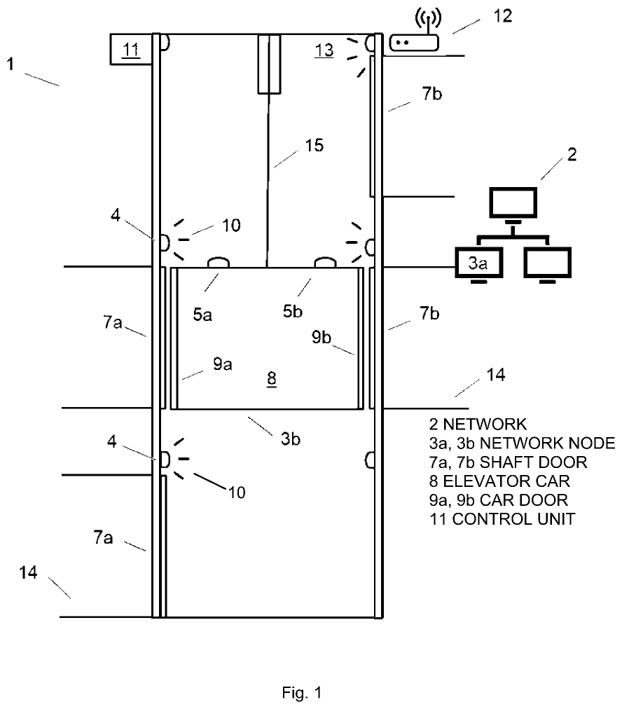

FIG. 1 shows an elevator system 1. In an elevator shaft 13 of the elevator system 1 comprising several floors or stopping stations 14, an elevator car 8 is carried by a support means 15, a shaft door 7a and/or 7b being provided in each stopping station 14. The elevator car 8 moves vertically in the elevator shaft 13 under the control of a control unit 11 of the elevator system 1 in order to transport passengers between different floors 14. The elevator car 8 has a left-hand car door 9a and a right-hand car door 9b, which are opposite one another but are completely identical in structure and function. When the car 8 arrives at a stopping station 14, the car doors 9a, 9b are then coupled to the shaft doors 7a, 7b, which are located in the stopping station, so that the car doors 9a or 9b and the shaft door 7a, 7b in the stopping station are always closed and opened together and at the same time.

Within the elevator system 1, there is a local data network or network 2 which is connected to other networks, for example the Internet, via a router or a gateway 12. If the data network 2 is a wireless network, the gateway or the router 12 is likewise a wireless device. Through the data network 2, all network nodes can be interconnected for communication. In this embodiment, each stopping station 14 forms a first network node 3a, while the elevator car 8 forms a second network node 3b of the data network 2. The network nodes 3a, 3b are each assigned a different network address, for example an IP address, from the router/gateway 12. The first network node 3a and the second network node 3b can exchange information on their own network address. The shaft door 7a or 7b belongs to the first network node 3a, and the car 8 to the second network node 3b. Since the network node 3b comprises two identical car doors 9a and 9b but only occupies a single IP address, it is initially unknown to the control unit 11 during the installation of the elevator system 1 which of the two doors is the left-hand car door 9a and which is the right-hand car door 9b.

To illuminate the elevator shaft 13, a light source 4 (for example an LED lamp) is arranged in the shaft 13 in any position that is available for a shaft door 7a, 7b or entrance/exit to the car 8. Since the control unit 11 is informed by the first network node 3a of the assignment of an IP address or the IP address, for example, the control unit 11 recognizes that this network node 3a is available or active. In addition, the control unit 11 also knows which floor the network node 3a is on. The control unit 11 then controls the light source 4 such that only the light sources 4 that are at the available network nodes 3a or at the available shaft doors 7a, 7b emit a light signal 10. The light sources 4 are controlled, for example, by digital signals that are generated by the control unit 11, a digital signal “1” corresponding to an available network node, and the digital signal otherwise being “0.” An example is given by a table below. An available shaft door is represented by a digital signal “1,” while a digital signal “0” represents an unavailable shaft door. The door numbers represent the specific individual shaft doors. Instead of such a door number, the respective product identity number of such doors can also be used. The door numbers are known to the control unit 11.

TABLE

| Floor | Door number | Left-hand shaft door | Right-hand shaft door |
|---|---|---|---|
| 0 | #1 | 1 | 0 |
| 1 | #2, #3 | 1 | 1 |
| 2 | #4 | 0 | 1 |
| 3 | — | 0 | 0 |

It can be seen from the table that there are a total of four floors for this elevator system 1. The third floor is not shown in FIG. 1 because no shaft door or no entrance/exit to the car 8 is provided on this floor. The control unit 11 therefore sends two “0” signals so that the two light sources 4 on this floor remain unlit.

Two light sensors 5a, 5b are arranged on the left and right respectively on the roof of the elevator car 8. If the car 8 travels along the shaft 13, the light sensors 5a, 5b can detect all of the lit-up light sources 4. If, for example, the left-hand light sensor 5a has detected a light signal 10 on the ground floor, the car 8 will assign this shaft door #1 7a to the light sensor 5a. The car 8 then informs the control unit 11 of this assignment of the shaft door #1 7a (as being on the left) and the IP address of this first network node 3a. The control unit 11 can then recognize the shaft door #1 as a left-hand shaft door on the first floor. In the same way, the shaft doors #2, #3 on the first floor can also be identified, shaft door #2 being noted for the left-hand side 7a and shaft door #3 for the right-hand side 7b. It can also be identified that, of the car doors 9a, 9b, the car door 9a is the left-hand car door and the car door 9b is the right-hand car door because they are connected to the left-hand shaft doors 7a and the right-hand shaft doors 7b. For this, the car 8 only needs to inform the control unit 11 of the door number of the car door 9a or 9b.

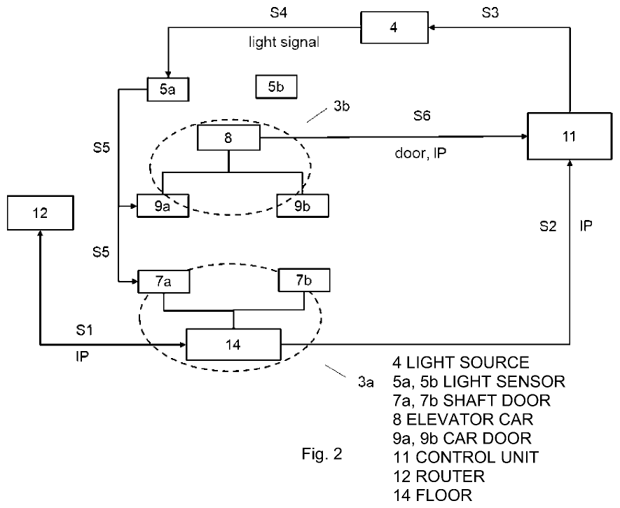

FIG. 2 is a schematic view of an identification method according to the invention. If, during installation of an elevator system 1, which is shown in FIG. 1, two shaft doors 7a, 7b in a stopping station 14 or two car doors 9a, 9b in a car 8 are to be distinguished from one another, the following method steps can be carried out, each method step being marked with “S”.
S1: a router 12 assigns an IP address to the network node 3a, for example, this network node 3a comprising two shaft doors 7a, 7b;
S2: the network node 3a informs the control unit 11 of its IP address;
S3: the control unit 11 activates a light source 4 on the basis of this information so that a light signal is generated;
S4: a light sensor 5a, for example, provided as a left-hand sensor, detects the light signal;
S5: the car 8, which is considered to be another network node 3b, has also received the IP address of the network node 3a. The car 8 assigns the shaft door 7a to the left-hand sensor 5a. The car 8 can also assign its car door 9a to the left-hand sensor 5a because this car door 9a is coupled to the shaft door 7a; and
S6: the car 8 notifies the control unit 11 that the shaft door 7a and the car door 9a are assigned to the left-hand sensor 5a. The notification also includes the door number of the shaft door 7a and the car door 9a and the IP address of the network nodes 3a and 3b.

In view of the communicated data, the control unit 11 can in this case clearly identify the two shaft doors 7a, 7b or the two car doors 9a, 9b as a left-hand or a right-hand shaft door or as a left-hand or a right-hand car door, respectively.

Finally, it should be noted that terms such as “comprising,” “having,” etc. do not preclude other elements or steps and terms such as “a” or “an” do not preclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1.-14. (canceled)

15. An elevator system including a data network having a network node, wherein the network node includes a component of the elevator system, the elevator system comprising:
a control unit controlling a light source to generate a light signal indicating the network node;
a light sensor that detects the light signal;
wherein the component of the network node is assigned to the light sensor when the light sensor detects the light signal; and
wherein the network node notifies the control unit of the assignment of the component.

16. The elevator system according to claim 15 wherein the network node informs the control unit of a network address of the network node and/or a network address of another network node of the data network.

17. The elevator system according to claim 15 wherein the network node corresponds to a stopping station of a car of the elevator system and the component is a shaft door at the stopping station, or the network node corresponds to a car of the elevator system and the component is a car door of the car.

18. The elevator system according to claim 17 wherein the stopping station is determined from a network address of the network node.

19. The elevator system according to claim 15 wherein the network node includes at least another component of the elevator system.

20. The elevator system according to claim 19 including another light sensor and wherein the light sensors are identified differently to the control unit according to positions of the light sensors relative to one another.

21. The elevator system according to claim 15 wherein the light source illuminates an elevator shaft of the elevator system and/or a stopping station of the elevator system.

22. An identification method for an elevator system, the system including a data network having a network node, wherein the network node includes a component of the elevator system, the method comprising the steps of:
operating a control unit of the elevator system to control a light source to generate a light signal indicating the network node;
assigning the component to a light sensor when the light sensor detects the light signal; and
communicating from the network node to the control unit the assignment of the component.

23. The identification method according to claim 22 including informing the control unit by the network node of a network address of the network node and/or a network address of another network node of the data network.

24. The identification method according to claim 23 wherein the network node corresponds to a stopping station of a car of the elevator system and the component is a shaft door at the stopping station, or the network node corresponds to car of the elevator system and the component is a car door of the car.

25. The identification method according to claim 24 wherein the stopping station is determined from a network address of the network node.

26. The identification method according to claim 22 wherein the network node includes at least another component of the elevator system.

27. The identification method according to claim 26 wherein the elevator system includes another light sensor, and including identifying the light sensors differently to the control unit according to positions of the light sensors relative to one another.

28. The identification method according to claim 22 including illuminating an elevator shaft of the elevator system and/or a stopping station of the elevator system by the light source.
